(19) United States
(12) Patent Application Publication
(10) Pub. No.: US 2024/0219738 A1
(43) Pub. Date: Jul. 4, 2024

(54) Head Worn Augmented Reality Displays

(71) Applicant: DigiLens Inc., Sunnyvale, CA (US)

(72) Inventors: Nima Shams, Sunnyvale, CA (US); George Hines, Sunnyvale, CA (US); Stanislav Dmitryiyev, Sunnyvale, CA (US); Nicholas Sherwood, Sunnyvale, CA (US); Alastair John Grant, San Jose, CA (US); Hyesog Lee, Sunnyvale, CA (US); Roger Allen Conley Smith, Sunnyvale, CA (US); John Border, Sunnyvale, CA (US); Joe Bietry, Sunnyvale, CA (US); Milan Momcilo Popovich, Leicester (GB); Suhas Maheshaiah, Sunnyvale, CA (US)

(73) Assignee: DigiLens Inc., Sunnyvale, CA (US)

(21) Appl. No.: 18/689,045

(22) PCT Filed: Sep. 2, 2022
(86) PCT No.: PCT/US22/75907

§ 371 Date: Mar. 4, 2024

Related U.S. Application Data
(60) Provisional application No. 63/240,680, filed on Sep. 3, 2021.
(60) Provisional application No. 63/263,153, filed on Oct. 27, 2021.

(51) Int. Cl. G02B 27/01; G02C 11/00

(52) U.S. Cl. CPC G02B 27/0172; G02C 11/10; G02B 2027/0138; G02B 2027/014; G02B 2027/0178

(57) ABSTRACT

Disclosed herein is a head worn augmented reality display including a waveguide assembly including a first waveguide and a second waveguide; a first projector configured to output image containing light towards a first waveguide, where the image containing light is inputted into total internal reflection in the first waveguide and then outputted towards a user's first eye; a second projector configured to output image containing light towards a second waveguide, where the image containing light is inputted into total internal reflection in the second waveguide and then outputted towards a user's second eye. The first waveguide and the second waveguide are substantially transparent to light from the outside environment such that both the image containing light and light from the outside environment enters the user's eyes.

### CROSS-REFERENCED APPLICATIONS

This application claims priority to U.S. Provisional Application No. 63/240,680 filed on Sep. 3, 2021 and U.S. Provisional Application No. 63/263,153 filed on Oct. 27, 2021, the disclosures of which are incorporated by reference in their entirety.

### FIELD OF THE INVENTION

The present invention generally relates to head worn augmented reality displays and more specifically to head worn augmented reality displays incorporating waveguide-based displays.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within or on the surface of the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal (LC) micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for Augmented Reality (AR) and Virtual Reality (VR), compact Heads Up Displays (HUDs) for aviation and road transport, and sensors for biometric and laser radar (LIDAR) applications. As many of these applications are directed at consumer products, there is a growing requirement for efficient low cost means for manufacturing holographic waveguides in large volumes.

### SUMMARY OF THE INVENTION

Various embodiments are directed to an augmented reality display including:
a waveguide assembly including a first waveguide and a second waveguide; a first projector configured to output image containing light towards a first waveguide, where the image containing light is inputted into total internal reflection in the first waveguide and then outputted towards a user's first eye; a second projector configured to output image containing light towards a second waveguide, where the image containing light is inputted into total internal reflection in the second waveguide and then outputted towards a user's second eye, where the first waveguide and the second waveguide are substantially transparent to light from the outside environment such that both the image containing light and light from the outside environment enters the user's eyes;
a front frame configured to house a circuit board including a processor and memory including programming executable by the processor to produce a user interface to be displayed in the image containing light from the first projector and the second projector;
a first temple which houses a first battery, wherein the first temple is connected to a first end of the front frame;
a second temple which houses a second battery, wherein the first temple is connected to a second end of the front frame opposite to the first end, and wherein the first temple and the second temple are configured to cooperate to secure the head worn augmented reality display to a user's head;
at least one camera; and
at least three microphones.

In various other embodiments, the at least three microphones include at least two microphones behind the first waveguide and/or the second waveguide which are shielded from external sound by the first waveguide and/or the second waveguide and at least one microphone spaced apart from the first waveguide and the second waveguide, wherein the at least three microphones form a microphone array to provide noise canceling.

In still various other embodiments, the at least one microphone spaced apart from the first waveguide and/or the second waveguide includes a first microphone positioned adjacent to a first tracking camera located at the first end and a second microphone positioned adjacent to a second tracking camera located at the second end.

In still various other embodiments, the at least one microphone spaced apart from the first waveguide and/or the second waveguide further comprises a third waveguide positioned near a temple tip of the first temple.

In still various other embodiments, the at least one camera comprises a center camera which is positioned in the middle of the front frame.

In still various other embodiments, the least one camera comprises a first tracking camera located at the first end and a second tracking camera located at the second end.

In still various other embodiments, the tracking cameras provide six degrees of freedom tracking.

In still various other embodiments, the augmented reality display further includes a global navigation satellite system (GNSS) antenna positioned such that the first battery is between the user's head and the GNNS antenna.

In still various other embodiments, the augmented reality display further includes a communication antenna positioned such that the second battery is between the user's head and the communication antenna.

In still various other embodiments, the communication antenna comprises a multiple input multiple output (MIMO) antenna.

In still various other embodiments, the MIMO antenna is a laser direct structuring (LDS) antenna.

In still various other embodiments, the waveguide assembly is attached to the front frame.

In still various other embodiments, the waveguide assembly is attached to the front frame by one or more screws.

In still various other embodiments, the waveguide assembly includes a waveguide frame which houses the first waveguide and the second waveguide.

In still various other embodiments, the first waveguide and the second waveguide form a single structure with a bridge connecting the first waveguide and the second waveguide.

In still various other embodiments, the first waveguide and/or the second waveguide comprise a waveguide stack.

In still various other embodiments, the waveguide stack comprises a red waveguide, a blue waveguide, and a green waveguide.

In still various other embodiments, the blue waveguide is sandwiched between the red waveguide and the green waveguide and the green waveguide is in closer proximity to the user's eyes than the red waveguide.

In still various other embodiments, the blue waveguide comprises glass substrates and the red waveguide and the green waveguide comprises plastic substrates.

In still various other embodiments, the waveguide stack further includes a protective cover is positioned between the green waveguide and the user's eye.

In still various other embodiments, the waveguide stack further includes a protective cover is positioned above the red waveguide on an opposite surface to the blue waveguide.

In still various other embodiments, the waveguide stack further comprises air gaps between adjacent waveguides.

In still various other embodiments, each waveguide in the waveguide stack includes a pair of substrates with a grating layer sandwiched between the pair of substrates.

In still various other embodiments, the pair of substrates comprises a pair of glass substrates or a pair of plastic substrates.

In still various other embodiments, the augmented reality display, further includes: a first pantoscopic tilt adjustment mechanism connecting the first temple to the first end of the front frame, where the first pantoscopic tilt adjustment mechanism is configured to adjust the tilt of the first temple; and a second pantoscopic tilt adjustment mechanism connecting the second temple to the second end of the front frame, where the second pantoscopic tilt adjustment mechanism is configured to adjust the tilt of the second temple.

In still various other embodiments, the first pantoscopic tilt adjustment mechanism and the second pantoscopic tilt adjustment mechanism include a friction spring configured to provide stiffness to the adjustment mechanisms and the detent is configured to lock the position of the adjustment mechanisms into a finite number of positions.

In still various other embodiments, the first pantoscopic tilt adjustment mechanism and/or the second pantoscopic tilt adjustment mechanism include a cable passthrough configured to pass through electrical cables from the first battery and/or the second battery to the circuit board.

In still various other embodiments, the augmented reality display further includes a vapor chamber positioned on a surface of the circuit board opposite to the user's eyes.

In still various other embodiments, the augmented reality display further includes a communication port positioned near a temple tip of the second temple.

In still various other embodiments, the communication port comprises a USB-C port.

In still various other embodiments, the first waveguide and/or the second waveguide include an input grating, a fold grating, and an output grating.

In still various other embodiments, the input grating and the fold grating are shielded by a portion of a waveguide frame.

In still various other embodiments, the input grating, the fold grating, and the output grating are holographic polymer dispersed liquid crystal gratings formed by a holographic exposure process.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure, wherein:

FIGS. 1A-1C are various perspective views of a head worn AR display in accordance with an embodiment of the invention.

FIGS. 2 and 3 are various views of a schematic of the head worn AR display of FIGS. 1A-1C showing the internal system components in more detail.

FIG. 4 is a schematic of the circuit board described in connection with FIGS. 2 and 3.

FIG. 5 is a perspective view of a head worn display in accordance with an embodiment of the invention.

FIGS. 6A-6C are a front view, side view, and rear view of the head worn display described in connection with FIG. 5.

FIGS. 7A-7C are a front view, side view, and rear view of the head worn display illustrated in FIGS. 6A-6C with details of internal system modules shown.

FIGS. 8A-8C illustrate various views of the head worn display of FIGS. 6A-6C with the integration of a removable protective shield which may be incorporated into the head worn display in accordance with an embodiment of the invention.

FIG. 9A illustrates a head worn display including an external power pack and USB-C wire connection in accordance with an embodiment of the invention.

FIG. 9B illustrates a head worn display including an 1800 mAh integrated battery in accordance with an embodiment of the invention.

FIG. 9C illustrates a head worn display including a hot-swappable battery configuration in accordance with an embodiment of the invention.

FIG. 10 illustrates a view of the picoprojector assembly in accordance with an embodiment of the invention.

FIG. 11A illustrates the picoprojector assembly of FIG. 10 integrated into the head worn display of FIGS. 1A-1C.

FIG. 11B illustrates the head worn display of FIGS. 1A-1C without the picoprojector assembly 1102.

FIGS. 12A-12B are a cross sectional view and a plan view of an embodiment of a waveguide which may be integrated into various head worn displays.

FIG. 13A illustrates a schematic of a display including a waveguide stack in accordance with an embodiment of the invention.

FIG. 13B illustrates a schematic of a display including a waveguide stack including a blue waveguide sandwiched between a red waveguide and a green waveguide.

FIGS. 14-16 illustrate different configurations of head worn AR displays in accordance with various embodiments of the invention.

FIGS. 17-18 are enlarged views of the pantoscopic tilt adjustment mechanism in accordance with an embodiment of the invention.

FIG. 19 illustrates a view of the head worn display of FIG. 5 with one side arm folded onto the eyepiece assembly.

FIG. 20 illustrates an enlarged view of the head worn display of FIG. 5 showing details of the pantoscopic tilt mechanism with one side arm folded.

FIG. 21 is an exploded view showing components of the hinge mechanism of FIG. 5 including the pantoscopic tilt adjustment mechanism.

FIG. 22 illustrates an explanation of the differences between various head tracking including no tracking, 3 degrees of freedom (3DoF) tracking, and 6 degrees of freedom (6DoF) tracking.

FIG. 23 illustrates a block diagram of various software applications which may be included in the head worn display in accordance with an embodiment of the invention.

FIGS. 24A-24B illustrate an example circuit board in the head worn display in accordance with various embodiments of the invention.

FIG. 25 illustrates a perspective view of the head worn display of FIG. 5.

FIG. 26 is a frontal view of the head worn display of FIG. 5.

FIG. 27 is a side view of the head worn display of FIG. 5.

FIG. 28 is a perspective view of the head worn display of FIG. 5 with the waveguide removed.

### DETAILED DESCRIPTION

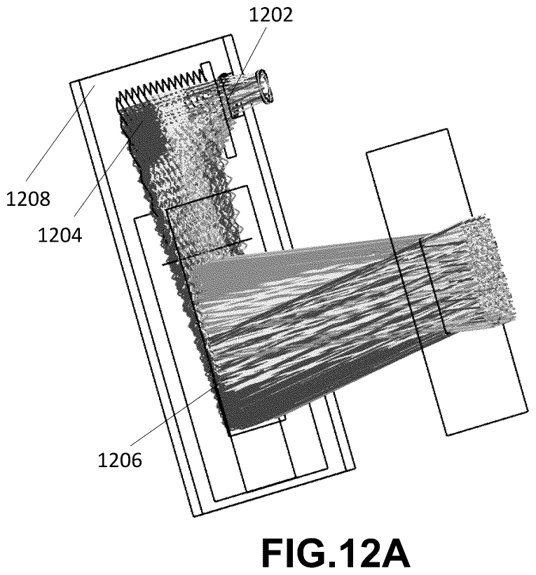

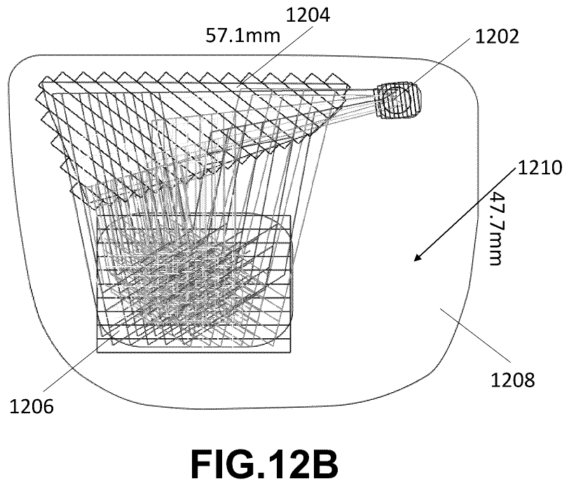

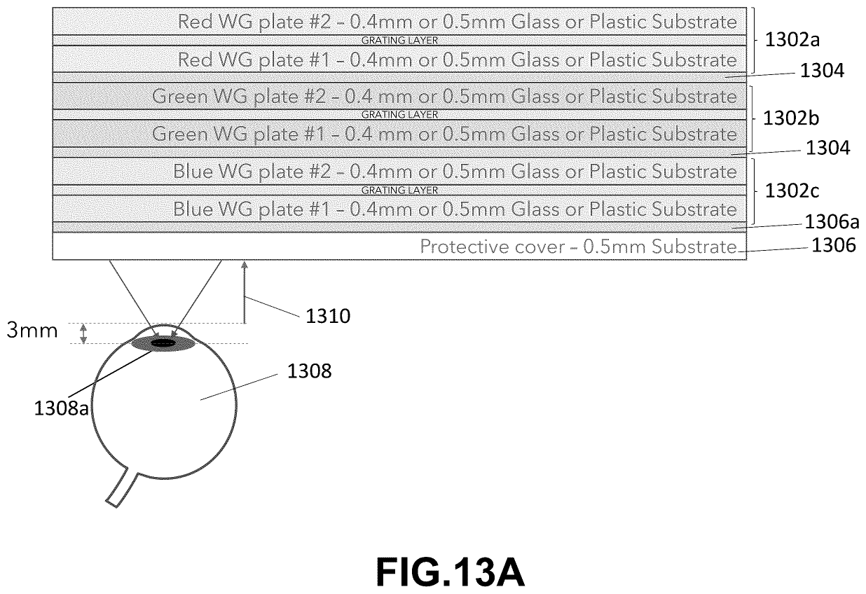

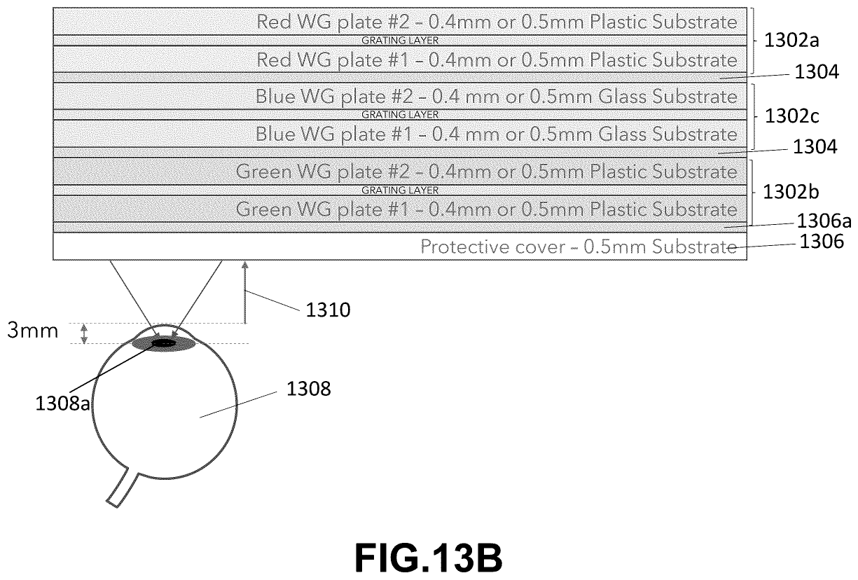

This application discloses various embodiments of a head worn waveguide based augmented reality (AR) display. This head worn display includes various improvements such as improvements to picoprojectors, projector-waveguide integration, eyeglass ergonomics, and user adjustments for optimizing viewing comfort and general wearability. This head worn display may include various features disclosed in WIPO Int. Pub. No. WO 2021/138607, entitled “Modular Waveguide Displays and Related Applications” and filed Dec. 31, 2020, which is hereby incorporated by reference in its entirety for all purposes. Details of the waveguide are described in connection with and illustrated in FIGS. 12A-12B and FIGS. 13A-13B.

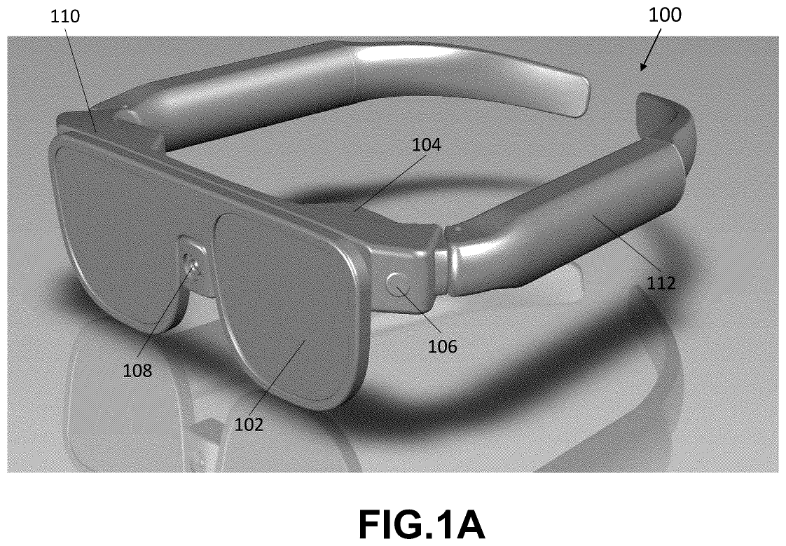

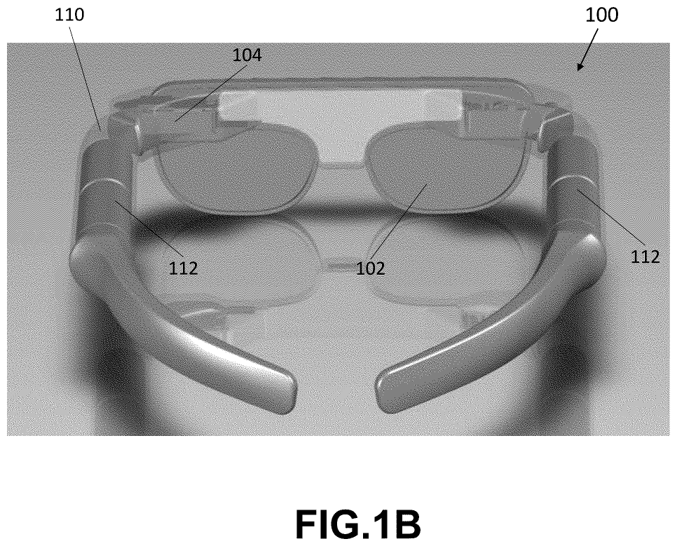

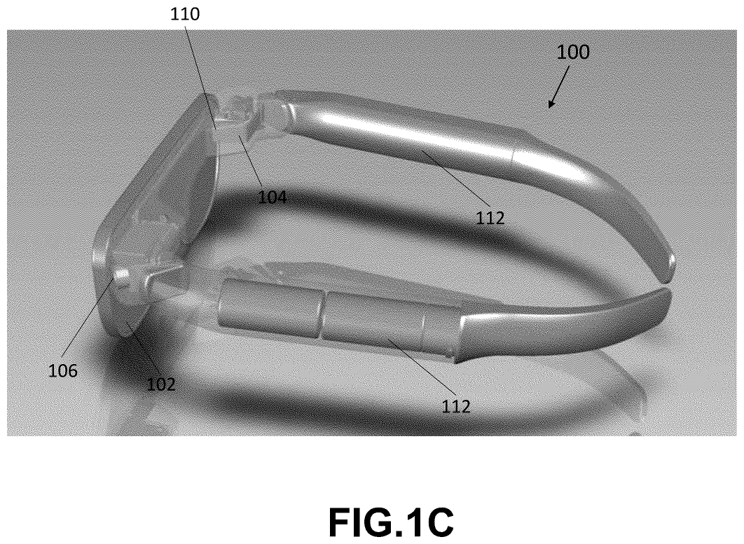

FIGS. 1A-1C are various perspective views of a head worn AR display in accordance with an embodiment of the invention. The head worn display 100 includes left and right eye waveguides 102. These waveguides 102 may include plastic. The waveguides 102 may be replaceable such that the head worn display 100 may be hot swappable with additional waveguides. The head worn display 100 includes left and right eye picoprojectors 104 which inject light including image information into the waveguides 102. Each picoprojector 104 may include one or more of RGB LED light sources, a dichroic beam splitter, a 720p LCoS panel, and/or a lens system for illuminating the LCoS panel and collimating and projecting light reflected from the panel into the respective waveguide. Advantageously, the lens system may allow the picoprojector 104 to be more compact than picoprojectors which are implemented without the lens systems. Thus, the picoprojectors 104 may be each integrated within a volume of 2.5 cc. While this specific picoprojector is described, various other picoprojectors are contemplated which include a compact form factor to be integrated into the head worn AR display 100. The picoprojectors 104 is configured to output image containing light towards the waveguides 102. The image containing light is inputting into total internal reflection in the waveguides 102. The picoprojectors 104 may be a first projector located on one side and a second projector located on a second side. The waveguides 102 are substantially transparent to light from the outside environment such that both the image containing light and light from the outside environment enters the user's eyes.

The head worn AR display 100 may further include one or more of tracking cameras 106. The tracking cameras 106 may include 6 degrees of freedom (6DoF) tracking. The tracking cameras 106 may be sensitive to depth. The tracking cameras 106 may include simultaneous localization and mapping (SLAM). The head worn display 100 may include a center camera 108 which may be a 48 MP camera using optical image stabilization (OIS) or electronic image stabilization (EIS) mounted in the nasal region of a frame 110. The center camera 108 may use 4×4 pixel binning which may aid in digital zoom capabilities. The head worn AR display 100 may further include one or more processors such as a Qualcomm Snapdragon 865 system on chip (SoC) XR-2 5G platform. The one or more processors may be located within the frame 110. The head worn AR display 100 may further include one or more power supplies 112 mounted on one or more of the temples of the frame 110. The power supplies 112 may be hot-swappable batteries. Memory may be located within the frame 110. The memory includes programming executable by the processor to produce a user interface to be displayed in the image containing light from the picoprojectors 104.

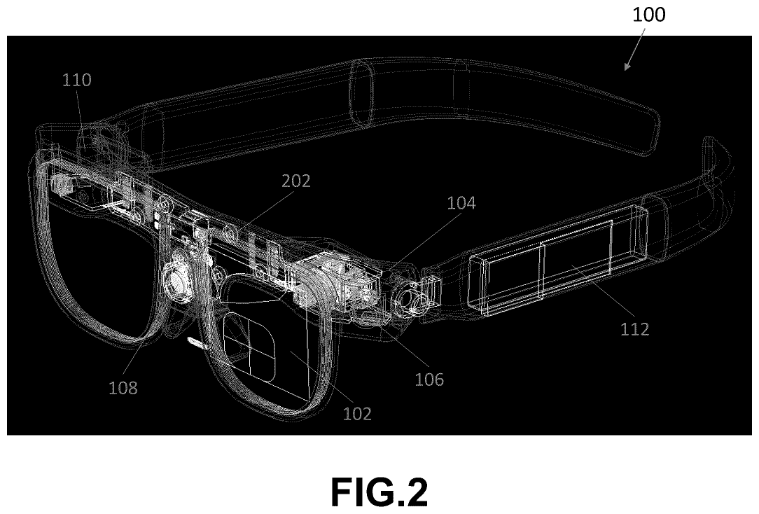

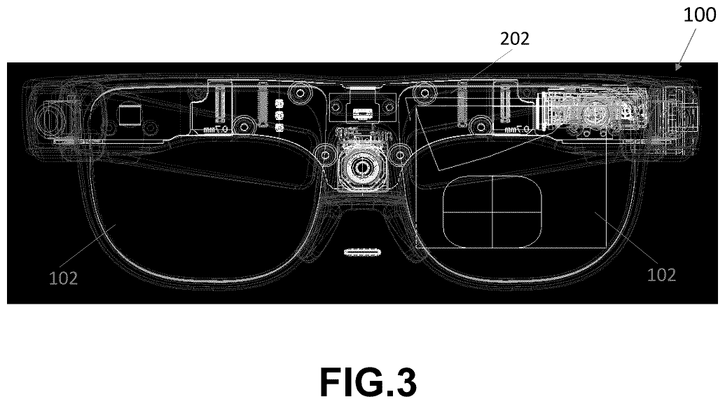

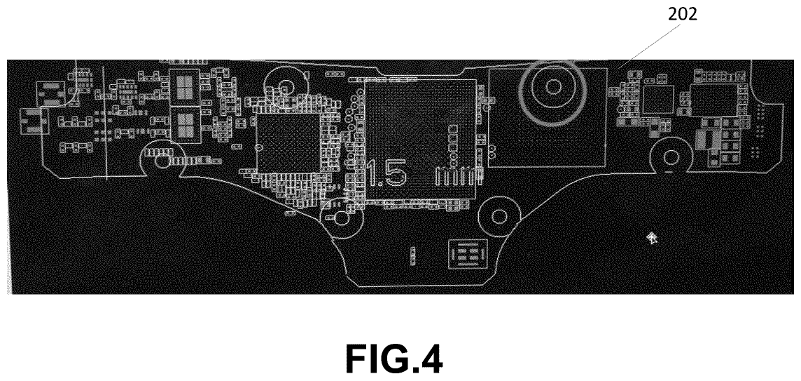

FIGS. 2 and 3 are various views of a schematic of the head worn AR display of FIGS. 1A-1C showing the internal system components in more detail. The head worn AR display 100 further includes a circuit board 202 which is housed in the frame 110. The circuit board 202 may include a processor and memory which may be utilized to control various aspects of the head worn AR display 100. For example, the circuit board 202 may control the projector 104 which may output image containing light into the waveguides 102. The circuit board 202 may also control the cameras 108, 106 which may capture various images. FIG. 4 is a schematic of the circuit board 202 described in connection with FIGS. 2 and 3.

The head worn AR display 100 may provide a display that meets the American National Standards Institute (ANSI) Z87 eye protection safety standard. The head worn AR display 100 may provide a display that is “dust tight” and protected against water ingress according to the IP65 Enclosure standard.

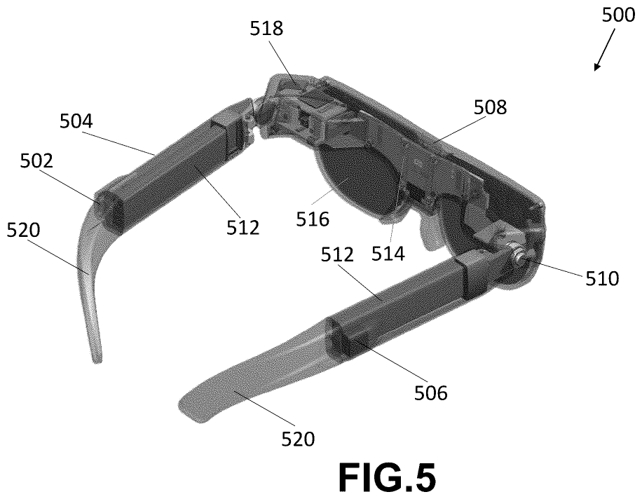

FIG. 5 is a perspective view of a head worn display in accordance with an embodiment of the invention. As illustrated, the head worn display 500 may include a waveguide assembly 516. The waveguide assembly 516 may be replaceable. The waveguide assembly 516 may be attached to a front frame 518. The waveguide assembly 516 may be replaceable. The waveguide assembly 516 may be precisely aligned to the frame during the replacement process through a ski-boot fastening process. The alignment of the waveguide assembly 516 and the projectors may be critical especially for image brightness. However, being replaceable, the waveguide assembly 516 may be easily misaligned with the projectors. The projectors and waveguide assembly 516 may be aligned by two mechanical features. First, a lip in which the frame comes down on and gets pushed in to capture it fairly accurately. Second, precision holes with screws that then tighten down the waveguide assembly 516.

The head worn display 500 includes a first temple which houses a battery 512, wherein the first temple is connected to a first end of the front frame 518. The head worn display 500 includes a second temple which houses a battery 512, wherein the second temple is connected to a second end of the front frame 518 opposite to the first end, and wherein the first temple and the second temple are configured to cooperate to secure the head worn display 500 to a user's head.

The head worn display 500 may further include a pantoscopic tilt mechanism 510. The pantoscopic tilt mechanism 510 may be used to adjust the pantoscopic tilt of the waveguide assembly 516. Adjusting the pantoscopic tilt may allow optimal viewing and comfort for the user of the head worn display 500. For example, when there is no pantoscopic tilt adjustment, the head worn display 500 may fold down the user's ears since the tilt of the temples may be improper. Also, adjusting the pantoscopic tilt may improve image quality in the waveguide assembly 516 by mitigating glint. Certain orientations of the waveguide assembly 516 may be less effected by glint and adjusting the pantoscopic tilt may allow the waveguide assembly 516 to be in these orientations.

The head worn display 500 may include a communication antenna 504 such as a laser direct structuring (LDS) multiple input multiple output (MIMO) antenna. The communication antenna 504 may be positioned such that the battery 512 is located between the user's head and the communication antenna 504. Further, the head worn display 500 may include a global navigation satellite system (GNSS) antenna 506. The GNSS antenna 506 may also include an integrated circuit (IC) assembly. The GNSS antenna 506 may be positioned such that the battery 512 is located between the user's head and the GNSS antenna 506. It may be advantageous to shield the radiation from the antennas 504, 506 from the user's head. Placing the battery 512 between the user's head and the antennas 504, 506 may provide radiation shielding for the user's head from radiation from the antennas 504, 506. The head worn display 500 may include a communication port 502. The communication port 502 may be a USB-C connector. The communication port 502 may be located near a temple tip 520 of one of the temples. The head worn display 500 may include an integrated vapor chamber 508 which may be utilized to cool the circuit board 514.

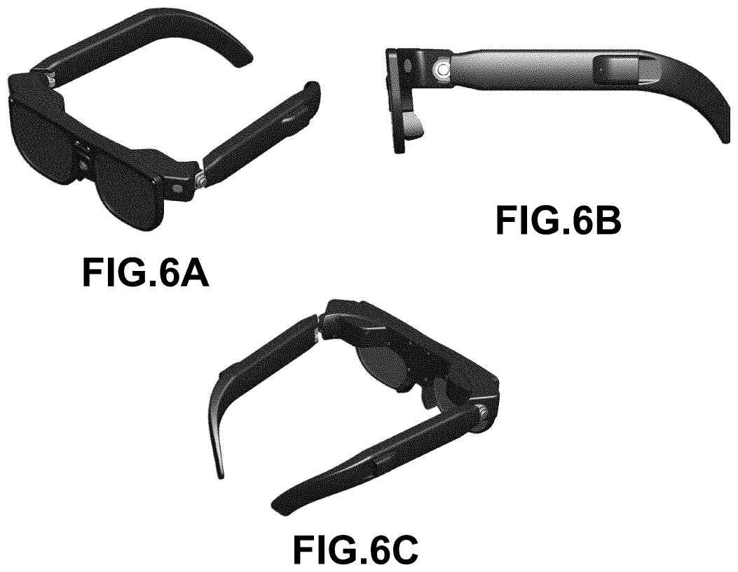

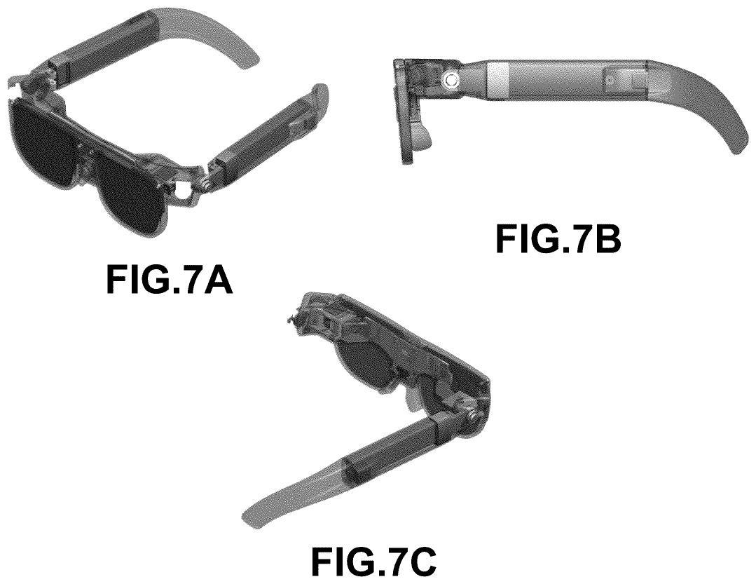

FIGS. 6A-6C are a front view, side view, and rear view of the head worn display described in connection with FIG. 5. FIGS. 7A-7C are a front view, side view, and rear view of the head worn display illustrated in FIGS. 6A-6C with details of internal system modules shown.

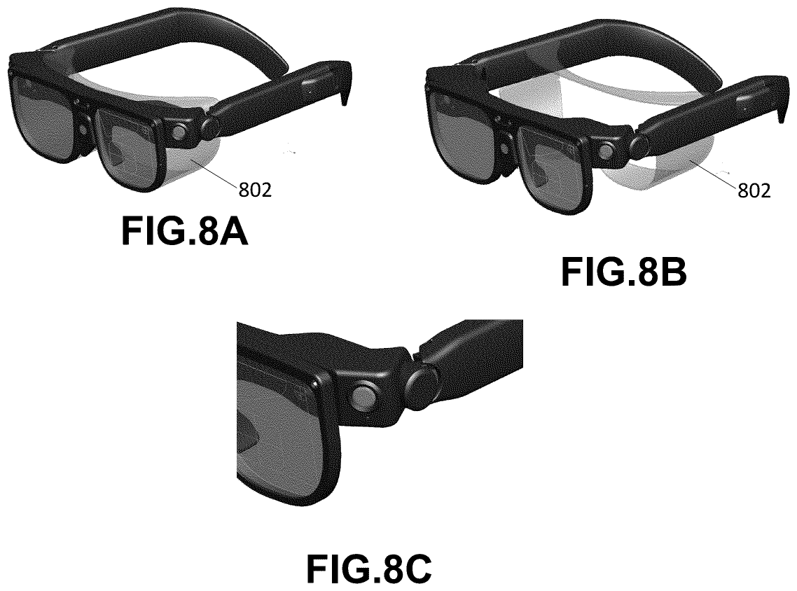

FIGS. 8A-8C illustrate various views of the head worn display of FIGS. 6A-6C with the integration of a removable protective shield which may be incorporated into the head worn display in accordance with an embodiment of the invention. The protective shield 802 may be an inner contoured mask which may be used to protect the user's eyes from projectiles. As illustrated in FIG. 8B, the protective shield 802 may be removed by sliding the protective shield 802 from the back of the head worn display.

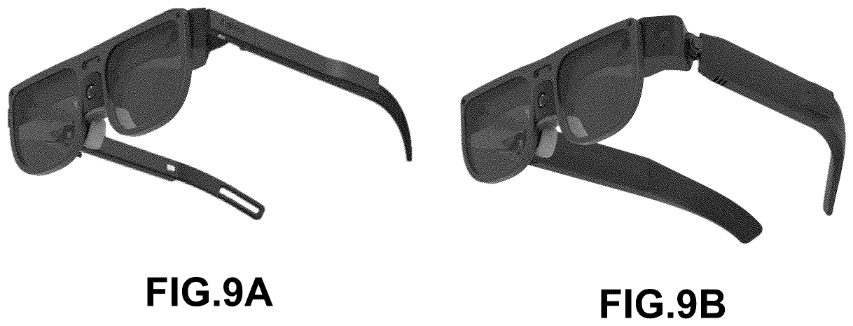

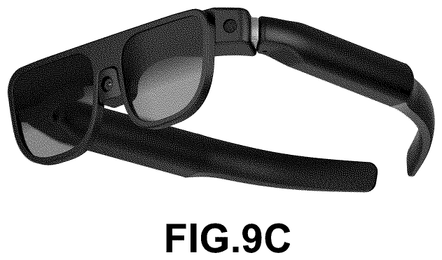

The head worn display according to the principles of the invention can be configured in various ways. FIG. 9A illustrates a head worn display including an external power pack and USB-C wire connection in accordance with an embodiment of the invention. This approach enables compact and lightweight glasses. In some examples, the weight of the head worn display may be around 120 grams. The head worn display may connect to a smart device through the USB-C connection which may be used to provide processing power to the head worn display. The smart device may be a smartphone or a tablet. Much of the processing power may not be present on the head worn display but instead may be provided by the smart device. Further, the head worn display may not include a battery but instead be powered through an external power source such as the smart device.

FIG. 9B illustrates a head worn display including an 1800 mAh integrated battery in accordance with an embodiment of the invention. In this embodiment, the head worn display is an integrated balanced solution which may weight around 180 grams. The head worn display may connect to a smart device similar to the device described in connection with FIG. 9A. The smart device may provide processing power for the head worn display which may allow the head worn device to be less robust which may decrease the weight of the head worn device. The smart device may also provide at least some of the battery power for the head worn device which may provide extra power to the head worn device.

FIG. 9C illustrates a head worn display including a hot-swappable battery configuration (e.g. the battery can be safely removed without disrupting system functions) in accordance with an embodiment of the invention. The battery configuration allows the power supply to provide weight/run-time flexibility (for example, using either one or two batteries per waveguide channel. In some embodiments, the batteries may be replaceable 16650 or CR123 cells with capacity up to 4000 mAh. The batteries may be housed within the arms of the head worn display. The battery of the head worn device of FIG. 9C may be larger than the battery of FIG. 9B which may add weight to the head worn device. The head worn device may or may not connect to an external smart device. The capabilities of the head worn device of FIG. 9C may be greater than the head worn device of FIG. 9B. The head worn device may be a stand alone device which may be capable of performing much of the functionality of a smart device.

While FIGS. 9A-9C illustrate three different specific configurations for the head worn display, it is understood that various configurations between these may mix and match features from the other configurations. For example, the head worn display of FIG. 9A may include a low capacity battery which may add to the weight of the device however may increase the capabilities of the device.

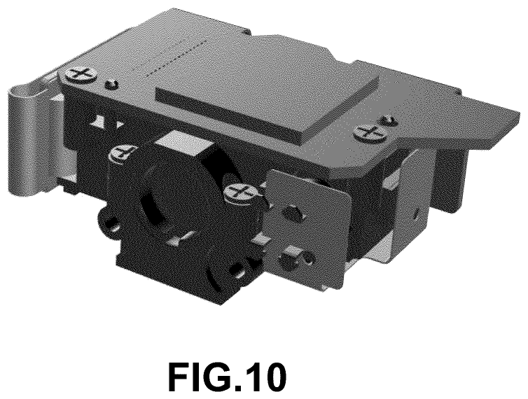

FIG. 10 illustrates a view of the picoprojector assembly in accordance with an embodiment of the invention. The picoprojector assembly may include a resolution of 720p. The picoprojector assembly may include an aspect ratio of 16:9 or 4:3. The orientation of the picoprojector assembly may be landscape or square. The field of view (FoV) of the picoprojector assembly may be greater than 30 degrees (e.g. 32 or 34 degrees). The picoprojector assembly may include a frame rate of greater than 90 frames per second. The picoprojector assembly may have infinite focus (e.g. greater than 2 meters). The maximum brightness may be greater than 4 p-lumens. The ANSI contrast ratio may be greater than 150:1. The color uniformity may be less than 0.020. The minimum MTF may be at greater than 20% or greater than 40% at Nyquist frequency. The picoprojector assembly may include a telecentric lens. The output pupil size may be 2-3 mm. The projector relief may be 4 mm. The lens f-number may be about 2.4. The distortion may be 1.7%. The target size may be 2 CC (20×10×10 mm). The operating temperature range may be −20 degrees C. to +50 degrees C. The storage temperature may be −20 degrees C. to +85 degrees C. The picoprojector assembly may including humidity resistance may operate as a humidity of 5-95%.

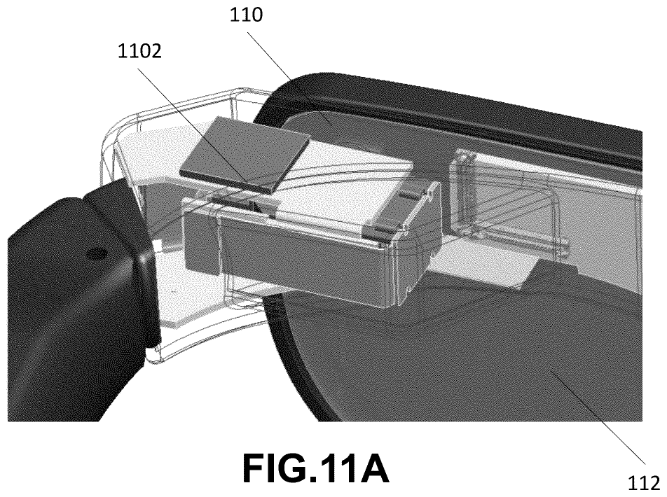

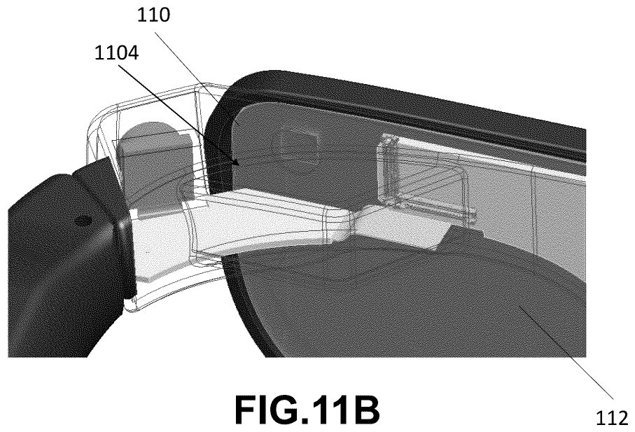

FIG. 11A illustrates the picoprojector assembly of FIG. 10 integrated into the head worn display of FIGS. 1A-1C. As illustrated, the picoprojector assembly 1102 may be integrated into a space 1104 in the frame 110 that is at the top of the temple adjacent to an edge of the waveguide 112. FIG. 11B illustrates the head worn display of FIG. 1A-1C without the picoprojector assembly 1102. Typically eyewear includes a space between a lens and the top of the temple which is empty. In order to make the head worn display as compact as possible, it has been discovered that positioning the picoprojector assembly 1102 in this space 1104 allows for a compact head worn display.

The picoprojector assembly 1102 may include a lens system including one or more lens elements disposed in the illumination optical path and one or more lens elements in the projection optical path. In some embodiments, the lens system may include an illumination path lens doublet and a projection lens doublet, with one or both of the lens doublets being air spaced. The illumination and LCoS-reflected beams may be polarization-separated using a wire grid polarizing beam splitter (PBS) plate. The picoprojector assembly 1102 may include a light source including RGB LED emitters encapsulated in condenser lenses with the RGB beams being combined by means of an X-cube dichroic prism system. In many embodiments, the above design or variants thereof may provide a projector/LED assembly volume smaller than 2.5 cc. In some embodiments, a different projector system than the picoprojector assembly 1102 described above may be utilized to inject light including image information into the waveguides. The projector assembly 1102 may be integrated on both sides to provide light including image information to the left waveguide and right waveguide. Each picoprojector assembly 1102 may be mounted near a hinge of the glasses using a floating suspension scheme that allows roll, pitch, yaw and X,Y,Z alignment to be fine-tuned before being frozen within an epoxy medium. As discussed above, the picoprojector assembly 1102 may not be fused to the waveguides 102 which allows the waveguides 102 to be swappable.

FIGS. 12A-12B are a cross sectional view and a plan view of an embodiment of a waveguide which may be integrated into the various head worn displays described above. The waveguide may include an input grating 1202, a fold grating 1204, and an output grating 1206 disposed within a waveguide substrate 1208 of area 57.1 mm×47.7 mm. Examples of ray paths within the waveguide and emerging from the waveguide into the eyebox are shown. The FOV supported by the waveguide may include a 30° diagonal with an aspect ratio of 4×3 (24°×18°) or 16×9 (26.15°×14.71°) depending on the applications. The waveguide may provide an eyebox of 12 mm×10 mm (elliptical) and an eye relief of 20 mm. Color imaging may be provided using waveguide layers optimized for RGB central wavelengths of 624 nm, 525 nm, 465 nm respectively. For example, different layers may be provided for the red image, the green image, and the blue image (see FIGS. 13A-13B below). The design may have a nominal rake angle of 0° which can be increased to −0.9° (towards the nose) to allow for vergence accommodation. The input grating may use an anisotropic material piecewise RKV design which is disclosed in U.S. patent application Ser. No. 17/822,625 entitled “Piecewise Rolled Vector Gratings and Methods of Fabrication” and filed on Aug. 26, 2022, which is hereby incorporated by reference in its entirety for all purposes. The fold grating 1204 and output grating 1206 in each waveguide layer may be recorded in an isotropic material. The fold grating 1204 may be positioned at the top of the waveguide to be positioned in front of the circuit board to avoid holographic glint from creating artifacts which may decrease image quality. It has also been discovered that positioning the fold grating 1204 at opposite space 1210 in the path of the input grating 1202 and the output grating 1206 may decrease the amount of glint which enters from the fold grating 1204 and degrades image quality.

In many embodiments, each waveguide may include three waveguides to provide full RGB coverage. In some embodiments, designs based on two waveguides one of which propagates two colors or even a single waveguide for propagating RGB may be used. All waveguides may be glass or plastic waveguide substrates. Waveguides that utilize plastic substrates offer the benefits of robustness against impact and hence greater safety, lower cost and the option of replaceable (or repairable) waveguides.

FIG. 13A illustrates a schematic of a display including a waveguide stack in accordance with an embodiment of the invention. The waveguide stack includes three waveguides 1302a, 1302b, 1302c Each of the three waveguides 1302a, 1302b, 1302c include gratings for propagating a different color (e.g. red, green, and blue). Each of the three waveguides 1302a, 1302b, 1302c may incorporate either plastic substrates or glass substrates with various refractive indices. Each of the three waveguides 1302a, 1302b, 1302c may incorporate a pair of substrates with a grating layer sandwiched between the pair of substrates. In some embodiments, the substrates may include a thickness of 0.4 mm to 0.5 mm. Adjacent waveguides may be separated by a gap 1304. The gap 1304 may be 10 μm. The gap 1304 may be larger than 10 μm which may minimize white light short coherence length) fringes from close proximity of two glass air interfaces. In some embodiments, hybrid solutions using waveguides 1302a, 1302b, 1302c incorporating plastic and glass substrates may be used. For example, the blue waveguide 1302c may include glass substrates whereas the red waveguide 1302a and the green waveguide 1302b may include plastic substrates. The glass substrates may include a refractive index between 1.5 and 1.7. The plastic substrates may have a refractive index between 1.5 and 1.69 or between 1.5 to 1.62. A protective cover 1306 may be positioned below the blue waveguide 1302c. The protective cover 1306 may be a 0.5 mm thick substrate. There may be an air gap 1306a between the protective cover 1306 and the blue waveguide 1302c. The protective cover 1306 may be located with an eye relief 1310 between the protective cover 1306 and the user's eye 1308 of 20 mm. Eye relief is distance from surface of waveguide stack to the surface of the observer eye. The Iris 1308a may be 3 mm from the surface of the user's eye 1308.

In some embodiments, the order of the waveguides 1302a, 1302b, 1302c may be significant. FIG. 13B illustrates a schematic of a display including a waveguide stack including a blue waveguide sandwiched between a red waveguide and a green waveguide. The blue waveguide 1302c may include glass substrates and the red waveguide 1302a and the green waveguide 1302b may include plastic substrates. The glass substrates may maximize the optical transmission of blue. It has been discovered that glass typically offer higher transmission of blue light than plastic and thus it is advantageous for the blue waveguide 1302c to include glass. Depending on where the color waveguide is located, may change the brightness of that particular color. For example, if the green waveguide 1302b is nearest to the user's eye 1308, then the perceived green brightness will be higher. In some embodiments, there may not be specifically defined red, green, and blue waveguides. For example, one of the waveguides may be a red waveguide and then the other ones may be colors which may be intermediate to green and blue depending on gaps in the color to be filled. In some embodiments, there may be an air spaced cover plate which may be applied on the surface of the waveguide display opposite to the user's eye 1308. This cover plate may protect the waveguide stack from contaminants.

In many embodiments, the waveguides 1302a, 1302b, 1302c can employ high index glass to provide angular carrying capacity. In many embodiments, a waveguide may have an efficiency greater than 800 nits/lumen (polarized). A waveguide with such an efficiency may provide more that 4000 nits to the user's eye 1308.

The waveguide is not limited to the specific designs discussed here. In many embodiments, the gratings are recorded in isotropic holographic photopolymers. In some embodiments, the gratings may be formed as holographic polymer dispersed liquid crystal (HPDLC) gratings, surface relief gratings (SRG) or evacuated Bragg gratings (EBG). Gratings may employ rolled K vectors or spatially varying grating properties (e.g. refractive index, grating modulation, birefringence, grating thickness, grating k-vector, grating pitch and other grating parameters). In some embodiments, waveguides may integrate layers for suppressing eyeglow. Various coatings and layers may be used in the waveguide including a reflective coating, a reflection grating, an alignment layer, and/or a polarization rotation layer. In some embodiments, the waveguide may employ an integrated dual axis (IDA) architecture. Examples of IDA architectures are described in U.S. Pat. Pub. No. 2020/0264378, entitled “Methods and Apparatuses for Providing a Holographic Waveguide Display Using Integrated Gratings” and filed Feb. 18, 2020, which is hereby incorporated by reference in its entirety.

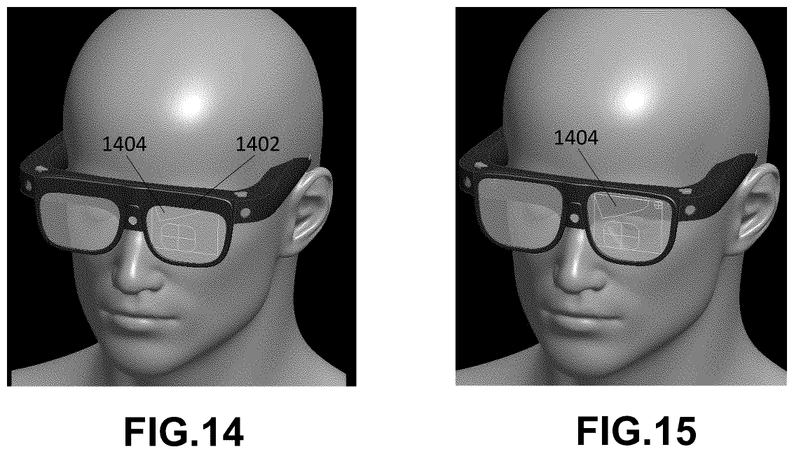

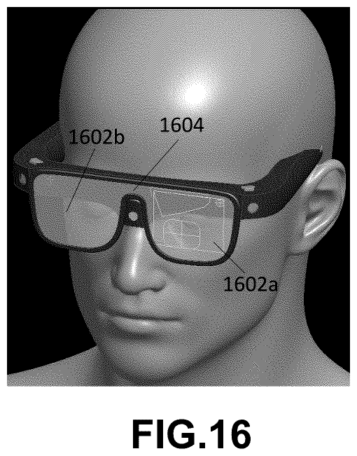

FIGS. 14-16 illustrate different configurations of head worn AR displays in accordance with various embodiments of the invention. FIG. 14 illustrates a configuration in which a waveguide frame 1402 may at least partially mask the fold grating 1404 shown in the upper portion of the waveguide on the right and the input grating. This has advantages in terms of blocking stray light (e.g. holographic glint) emitted by the fold grating 1404 and the input grating. FIG. 15 illustrates a configuration in which there is no partial masking of the fold grating 1404. However, as illustrated the fold grating is positioned to overlap with the circuit board and frame which may block stray light. FIG. 16 shows an embodiment in which the left eye waveguide 1602b and the right eye waveguide 1602a are formed in a single substrate. As illustrated the left eye waveguide 1602b and the right eye waveguide 1602a are connected through bridge 1604 in the middle. Such a configuration may be difficult to achieve using surface relief grating waveguide since such large-scale fabrication is difficult with nanoimprint lithographic processes. A holographic process may be useful in producing the left eye waveguide 1602b and the right eye waveguide 1602a as an integrated waveguide. The left eye waveguide 1602b and the right eye waveguide 1602a may include an input grating, a fold grating, and an output grating which may be holographic polymer dispersed liquid crystal gratings formed by a holographic exposure process. Further, having the left eye waveguide 1602b and the right eye waveguide 1602a as a single waveguide may make it easier to align the waveguides when swapping them.

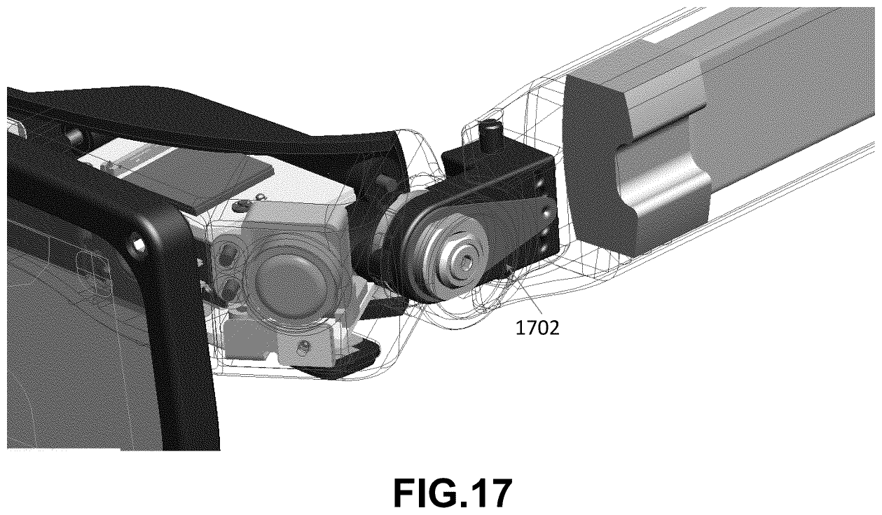

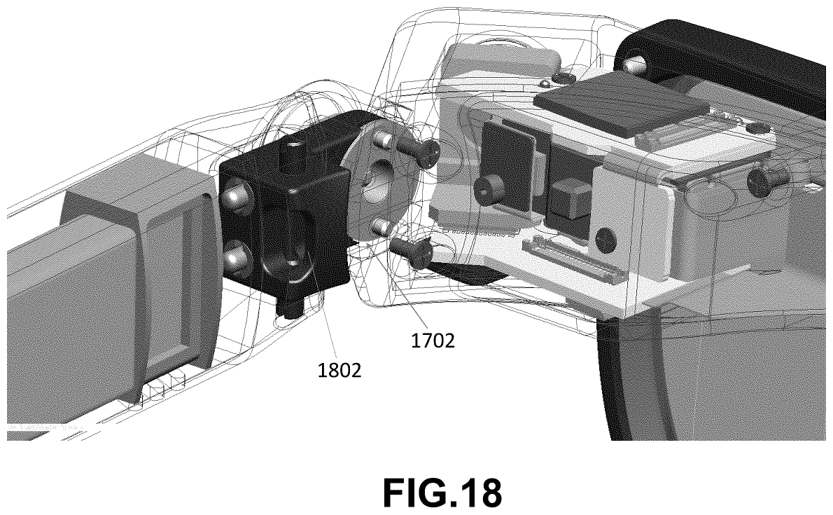

The head worn AR display may include features for achieving user comfort and visual alignment for different ear and eye horizontal plane offsets and head sizes. The offset can vary considerably, since ears can be higher or lower than the eye horizontal plane. The headset may include a pantoscopic tilt adjustment mechanism to adjust the tilt of the waveguides. The pantoscopic tilt adjust mechanism can be adjusted to accommodate different face configurations by providing an adjustment at the temples to keep the glasses aligned to the user's eyes while still maintaining the ear pieces of the head worn display positioned on the user's ears. FIGS. 17-18 are enlarged views of the pantoscopic tilt adjustment mechanism in accordance with an embodiment of the invention. FIG. 17 shows the front of the pantoscopic tilt adjustment mechanism whereas FIG. 18 shows the back of the pantoscopic tilt adjustment mechanism. As shown, the mechanism allows stepwise rotation through five eyeglass vertical tilt positions. Different numbers of vertical tilt positions have been contemplated. The pantoscopic tilt adjustment mechanism 1702 includes a friction spring and a detent. The friction spring allows the pantoscopic tilt adjustment mechanism 1702 to be stiff and thus allows the user to finely tune the amount of tilt applied to the waveguides. The detent locks the position of the pantoscopic tilt adjustment mechanism 1702 into a finite number of positions. The detent may be used to reinforce the friction spring in locking the tilt of the waveguides. The detect may force the positioning of the left and right side to be identical and thus decrease the likelihood of uneven tilt of the left and right side. Adjusting the tilt of the waveguides may allow the user to adjust the useful angle of the waveguides. For example, if a user desires to view an augmented image while looking downwards, the user may adjust the tilt of the waveguides to point downwards. Adjusting the tilt of the waveguides may also aid in reducing the amount of perceived light ejected away from the user (e.g. eye glow). Eye glow is typically directional and thus tilting the waveguides downwards may eject light downwards as opposed to towards the public. Tilting the waveguides to a specific orientation may also mitigate glint. The pantoscopic tilt adjustment mechanism 1702 may include a cable passthrough 1802 which may be used to pass through electrical cables. For example, a power cable may pass from the battery to the circuit board.

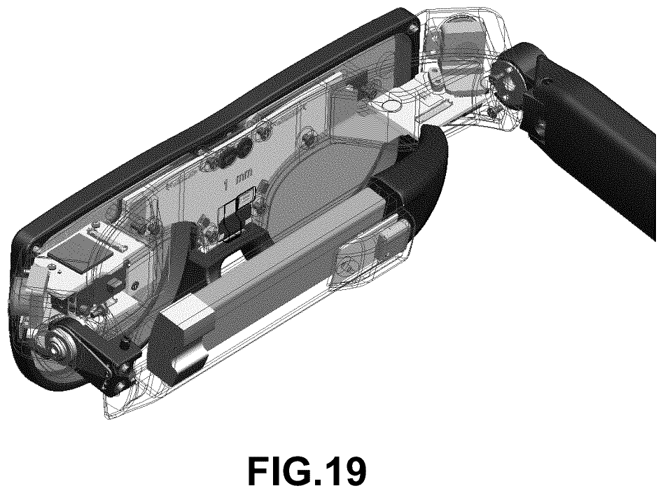

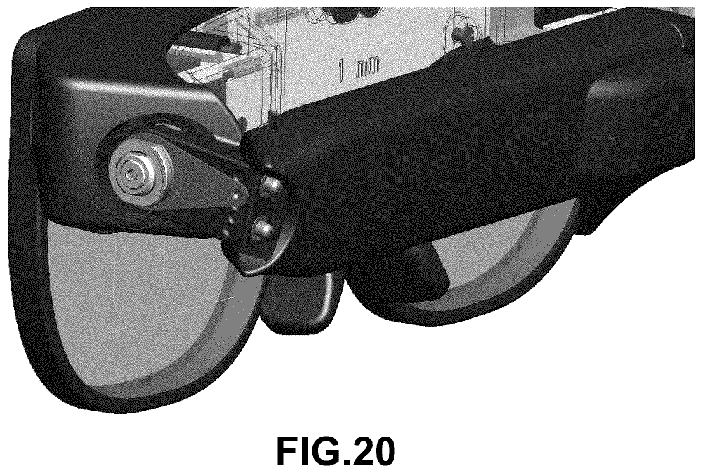

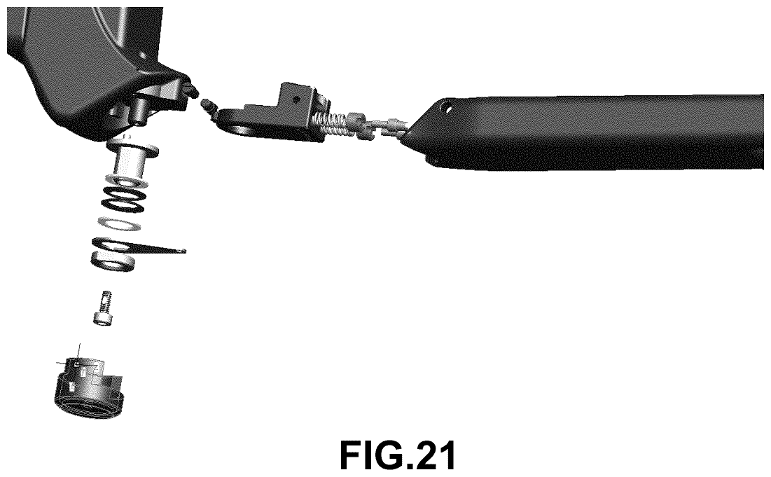

FIG. 19 illustrates a view of the head worn display of FIG. 5 with one side arm folded onto the eyepiece assembly. FIG. 20 illustrates an enlarged view of the head worn display of FIG. 5 showing details of the pantoscopic tilt mechanism with one side arm folded. FIG. 21 is an exploded view showing components of the hinge mechanism including the pantoscopic tilt adjustment mechanism.

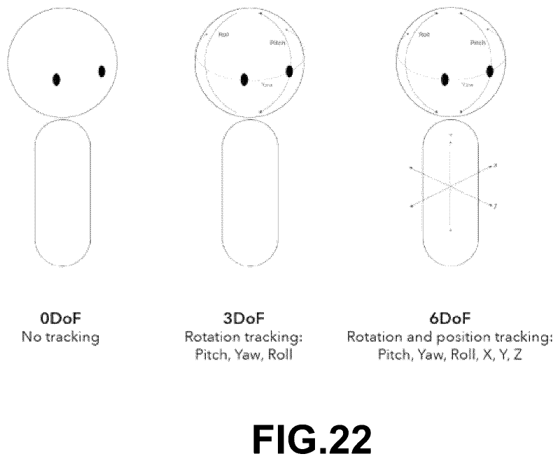

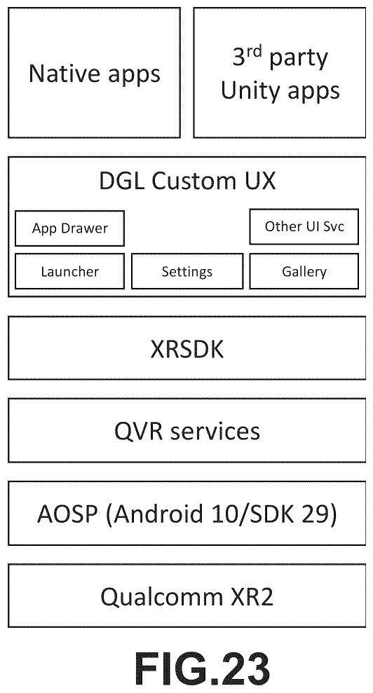

FIG. 22 illustrates an explanation of the differences between various head tracking including no tracking, 3 degrees of freedom (3DoF) tracking, and 6 degrees of freedom (6DoF) tracking. The head worn display may incorporate either of these options. 6DoF tracking may enable various applications such as location locked objects. FIG. 23 illustrates a block diagram of various software applications which may be included in the head worn display in accordance with an embodiment of the invention.

The software may include modules for driving the sensors, camera, spatial audio, and other system modules. The head worn display may employ an Android 10 open source (AOSP) operating system. The design may meet full Qualcomm Snapdragon XR-2 System (8-core) specification. The system may incorporate computer vision, visual odometer, dual camera depth triangulation, simultaneous localization and mapping (SLAM), plane detection, object detection, voice control, ambient light sensing, head tracking, eye tracking, and/or others. The system may include an application programming interface (API), geolocation integration and beacon technology. Various custom applications can be incorporated including a user orbiting operating system, spatial integration, a spatial application programming interface (API), a partner application, over-the-air (OTA) programming, support for Open XR and other open standards for providing high-performance access to Augmented Reality (AR) and Virtual Reality (VR), a game engine (e.g. Unity & Unreal Game Engine), and/or others.

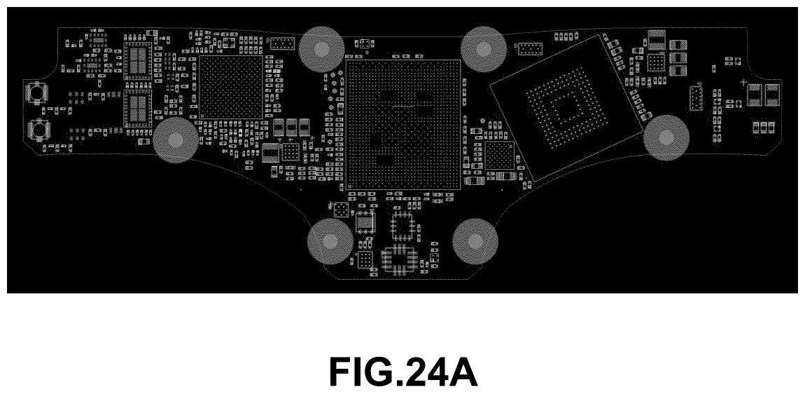

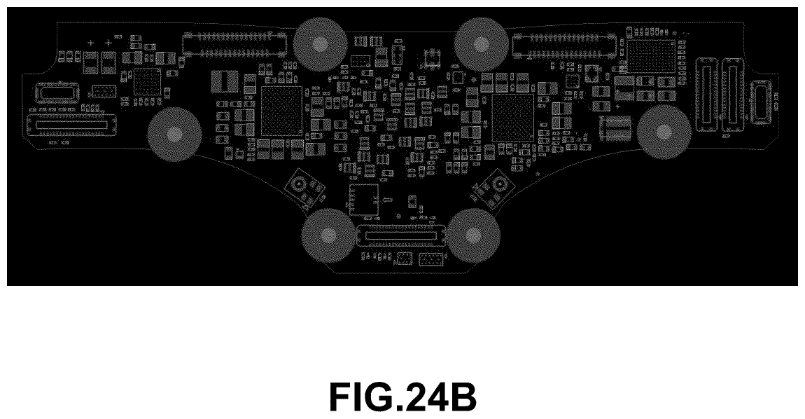

FIGS. 24A-24B illustrate an example circuit board in the head worn display in accordance with various embodiments of the invention. FIG. 24A is the front side of the circuit board whereas FIG. 24B is the back side of the circuit board. In some embodiments, the circuit board may include many of the features of a smart device incorporated into the head worn display. A metal front frame may be used as an RF shield and a heatsink to the circuit board. The metal front frame may be magnesium. In some embodiments, the GNSS antenna may be placed far away from the circuit board which may be a main source of noise.

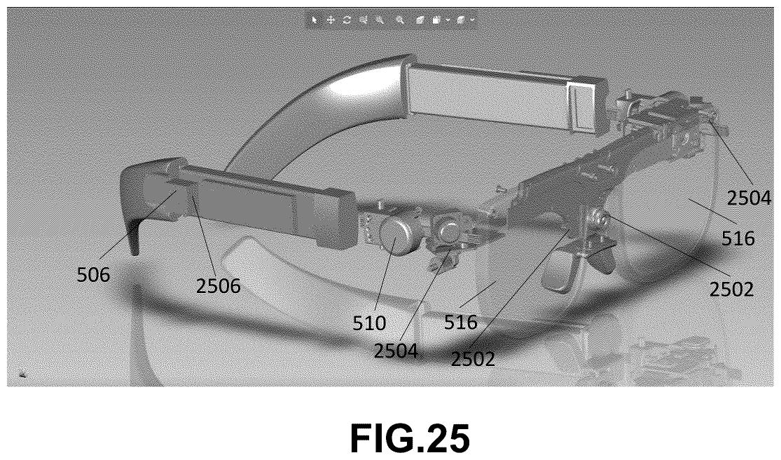

FIG. 25 illustrates a perspective view of the head worn display of FIG. 5. The description of identically numbered features from FIG. 5 is applicable to FIG. 25 and these descriptions will not be repeated in detail. These features include but are limited to design mechanisms for properly dissipating heat away from the user. In some embodiments, the front chassis of the frame of the head worn display may be metal with graphene on the inside to spread the heat all the way to the hinges of the frame. The backside of the frame facing the user may be plastic or nylon (e.g. TR90) with close foam pads so that the user does not feel the heat. In some embodiments the foam pads may provide an air gap between the head worn display and a user. The processor may be positioned on the side of the circuit board furthest away from the user so the heat dissipates into the frame and out to the surrounding environment rather than being experienced by the user. The LED projectors may include LEDs which may be located furthest away from the user's head and dissipate heat into the metal/hinges rather than towards the center where the user can feel it the most.

The head worn display may include at least three microphones. The head worn display may include a five microphone system with two microphones 2502 next to the user mounted behind the waveguide assembly 516, two microphones 2504 in the far corner by the tracking cameras, and one microphone 2506 near the back earhorn which may capture directionality of sound waves from the front, back, and sides. The microphones may work as a microphone array to provide noise cancelling. The microphone 2506 near the back earhorn may allow for noise cancelation due to their placement away from the other microphones. The microphones 2502 positioned behind the waveguide assembly 516 may be shielded from external sound whereas they may be closer to sound from the user such as the user's speech. Advantageous, shielding the external sound may lengthen the path of the sound which reaches these microphones 2502 whereas the two microphones 2504 adjacent to the tracking cameras may be unobstructed to external sound which may aid in noise cancelling.

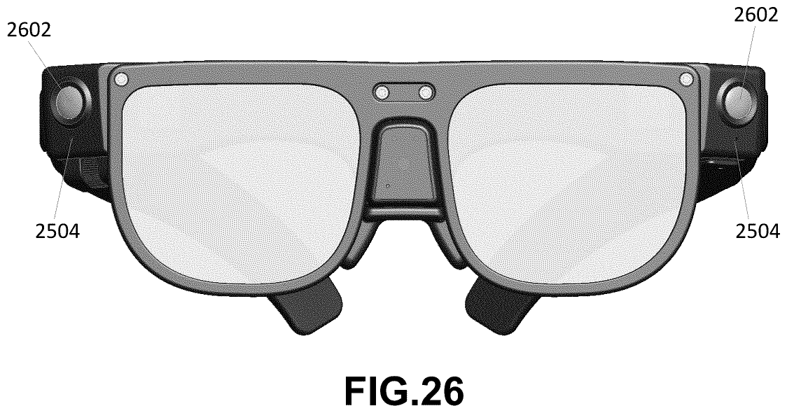

FIG. 26 is a frontal view of the head worn display of FIG. 5. As illustrated, two microphones 2504 may be positioned in the far corner by the tracking cameras 2602.

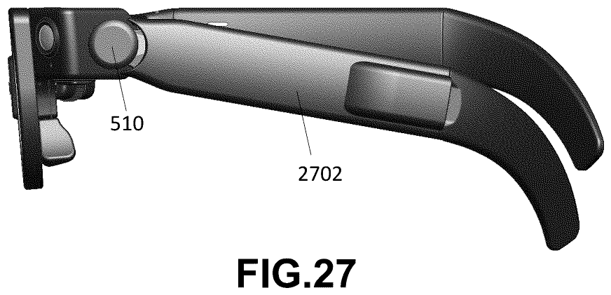

FIG. 27 is a side view of the head worn display of FIG. 5. As illustrated, the pantoscopic tilt adjustment mechanism 510 may adjust the tilt of the side arms 2702 from various positions. The side arms 2702 may move up and down. The side arms 2702 can move in a fixed amount of range such as 10 degrees.

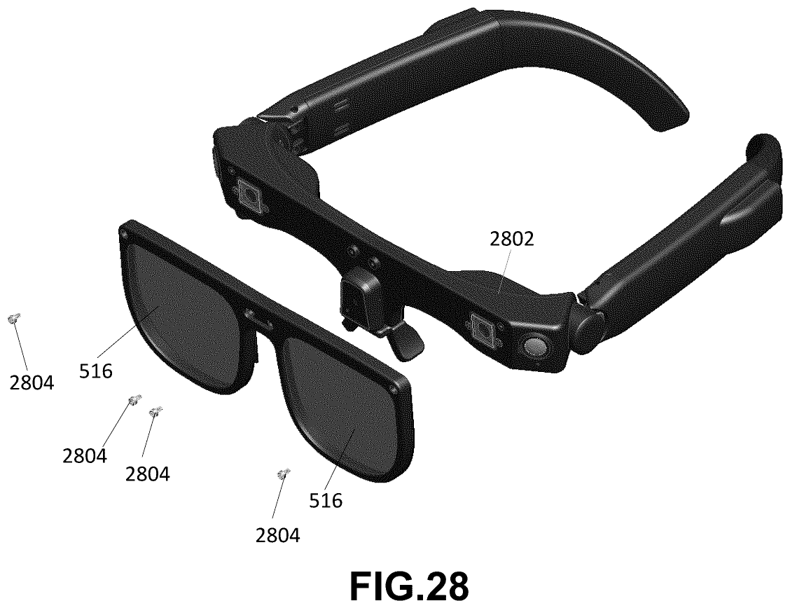

FIG. 28 is a perspective view of the head worn display of FIG. 5 with the waveguide removed. As illustrated, the waveguides 516 may be removable from the frame 2802 of the head worn display. The waveguides 516 may be secured to the frame through the use of screws 2804.

While many features have been described in different implementations of head worn displays it is understood that these features are combinable into a single device. For example, the head worn display of FIGS. 1A-1C may include the microphone configuration described in connection with FIG. 25. Also, the pantoscopic tilt adjustment mechanism described in connection with FIG. 5 may be utilized in the head worn display of FIGS. 1A-1C.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An augmented reality display comprising:
a waveguide assembly including a first waveguide and a second waveguide;
a first projector configured to output image containing light towards a first waveguide, wherein the image containing light is inputted into total internal reflection in the first waveguide and then outputted towards a user's first eye;
a second projector configured to output image containing light towards a second waveguide, wherein the image containing light is inputted into total internal reflection in the second waveguide and then outputted towards a user's second eye, wherein the first waveguide and the second waveguide are substantially transparent to light from the outside environment such that both the image containing light and light from the outside environment enters the user's eyes;
a front frame configured to house a circuit board including a processor and memory including programming executable by the processor to produce a user interface to be displayed in the image containing light from the first projector and the second projector;
a first temple which houses a first battery, wherein the first temple is connected to a first end of the front frame;
a second temple which houses a second battery, wherein the second temple is connected to a second end of the front frame opposite to the first end, and wherein the first temple and the second temple are configured to cooperate to secure the augmented reality display to a user's head;
at least one camera; and
at least three microphones.

2. The augmented reality display of claim 1, wherein the at least three microphones include at least two microphones behind the first waveguide and/or the second waveguide which are shielded from external sound by the first waveguide and/or the second waveguide and at least one microphone spaced apart from the first waveguide and the second waveguide, wherein the at least three microphones form a microphone array to provide noise canceling.

3. The augmented reality display of claim 2, wherein the at least one microphone spaced apart from the first waveguide and/or the second waveguide comprises a first microphone positioned adjacent to a first tracking camera located at the first end and a second microphone positioned adjacent to a second tracing camera located at the second end.

4. The augmented reality display of claim 3, wherein the at least one microphone spaced apart from the first waveguide and/or the second waveguide further comprises a third microphone positioned near a temple tip of the first temple.

5. The augmented reality display of claim 1, wherein the at least one camera comprises a center camera which is positioned in a middle of the front frame.

6. The augmented reality display of claim 1, wherein the least one camera comprises a first tracking camera located at the first end and a second tracking camera located at the second end.

7. The augmented reality display of claim 6, wherein the tracking cameras provide six degrees of freedom tracking.

8. The augmented reality display of claim 1, further comprising a global navigation satellite system (GNSS) antenna positioned such that the first battery is between the user's head and the GNSS antenna.

9. The augmented reality display of claim 1, further comprising a communication antenna positioned such that the second battery is between the user's head and the communication antenna.

10. The augmented reality display of claim 9, wherein the communication antenna comprises a multiple input multiple output (MIMO) antenna.

11. The augmented reality display of claim 10, wherein the MIMO antenna is a laser direct structuring (LDS) antenna.

12. The augmented reality display of claim 1, wherein the waveguide assembly is attached to the front frame.

13. The augmented reality display of claim 12, wherein the waveguide assembly is attached to the front frame by one or more screws.

14. The augmented reality display of claim 1, wherein the waveguide assembly includes a waveguide frame which houses the first waveguide and the second waveguide.

15. The augmented reality display of claim 14, wherein the first waveguide and the second waveguide form a single structure with a bridge connecting the first waveguide and the second waveguide.

16. The augmented reality display of claim 1, wherein the first waveguide and/or the second waveguide comprise a waveguide stack.

17. The augmented reality display of claim 16, wherein the waveguide stack comprises a red waveguide, a blue waveguide, and a green waveguide.

18. The augmented reality display of claim 17, wherein the blue waveguide is sandwiched between the red waveguide and the green waveguide and wherein the green waveguide is in closer proximity to the user's eyes than the red waveguide.

19. The augmented reality display of claim 18, wherein the blue waveguide comprises glass substrates and the red waveguide and the green waveguide comprises plastic substrates.

20. The augmented reality display of claim 18, wherein the waveguide stack further comprises a protective cover is positioned between the green waveguide and the user's eyes.

21. The augmented reality display of claim 18, wherein the waveguide stack further comprises a protective cover is positioned above the red waveguide on an opposite surface to the blue waveguide.

22. The augmented reality display of claim 17, wherein the waveguide stack further comprises air gaps between adjacent waveguides.

23. The augmented reality display of claim 16, wherein each waveguide in the waveguide stack comprises a pair of substrates with a grating layer sandwiched between the pair of substrates.

24. The augmented reality display of claim 23, wherein the pair of substrates comprises a pair of glass substrates or a pair of plastic substrates.

25. The augmented reality display of claim 1, further comprising:
a first pantoscopic tilt adjustment mechanism connecting the first temple to the first end of the front frame, wherein the first pantoscopic tilt adjustment mechanism is configured to adjust the tilt of the first temple; and
a second pantoscopic tilt adjustment mechanism connecting the second temple to the second end of the front frame, wherein the second pantoscopic tilt adjustment mechanism is configured to adjust the tilt of the second temple.

26. The augmented reality display of claim 25, wherein the first pantoscopic tilt adjustment mechanism and the second pantoscopic tilt adjustment mechanism comprise a friction spring configured to provide stiffness to the adjustment mechanisms and a detent is configured to lock the position of the adjustment mechanisms into a finite number of positions.

27. The augmented reality display of claim 25, wherein the first pantoscopic tilt adjustment mechanism and/or the second pantoscopic tilt adjustment mechanism comprise a cable passthrough configured to pass through electrical cables from the first battery and/or the second battery to the circuit board.

28. The augmented reality display of claim 1, further comprising a vapor chamber positioned on a surface of the circuit board opposite to the user's eyes.

29. The augmented reality display of claim 1, further comprising a communication port positioned near a temple tip of the second temple.

30. The augmented reality display of claim 29, wherein the communication port comprises a USB-C port.

31. The augmented reality display of claim 1, wherein the first waveguide and/or the second waveguide comprise an input grating, a fold grating, and an output grating.

32. The augmented reality display of claim 31, wherein the input grating and the fold grating are shielded by a portion of a waveguide frame.

33. The augmented reality display of claim 31, wherein the input grating, the fold grating, and the output grating are holographic polymer dispersed liquid crystal gratings formed by a holographic exposure process.
